(19) United States
(12) Patent Application Publication
(10) Pub. No.: US 2025/0225606 A1
(43) Pub. Date: Jul. 10, 2025

(54) PSYCHO-VISUAL-MODEL BASED VIDEO WATERMARK LUMA LEVEL ADAPTATION

(71) Applicant: Verance Corporation, San Diego, CA (US)

(72) Inventors: Patrick George Downes, San Diego, CA (US); Rade Petrovic, Fremont, CA (US)

(21) Appl. No.: 18/849,454

(22) PCT Filed: Mar. 22, 2022
(86) PCT No.: PCT/US2022/021445

§ 371 Date: Jan. 10, 2025

(51) Int. Cl. G06T 1/00

(52) U.S. Cl. CPC G06T 1/0028; G06T 1/005; G06T 2201/0065

(57) ABSTRACT

A method for embedding video watermarks. Areas of poor visual quality in a video content having embedded watermarks are determined. The watermark symbols replace pixels in the video content with pixels in which the luma values are modulated such the luma value for a 0 bit renders as black and the luma value for a 1 bit renders a shade of gray. The selection of the luma value for bit 1 takes into account the visual impact of watermark embedding. When extracting video watermark symbols from embedded content, predictions are made regarding the expected luma value for bit 1 selected during the embedding in order to calculate the threshold used to discriminate bits 0 and 1.

### FIELD OF INVENTION

The present disclosure generally relates to watermarking digital content and more particularly to enhancements to video watermarking systems.

### BACKGROUND

This section is intended to provide a background or context to the disclosed embodiments that are recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video watermarking (VWM) system which embeds ancillary information into a video signal is found in the ATSC 3.0 standard A/335. The embedder in this system replaces the luma of the top two lines of pixels with a value which is modulated by the ancillary data. Binary data is represented by two different luma values, where the luma value for a ‘0’ bit (“Bit0”) renders as black and the luma for a ‘1’ bit (“Bit1”) renders as a shade of gray. The detector in this system sets a fixed symbol detection threshold based on a histogram analysis of luma values across the entire top line of a frame.

### BRIEF DESCRIPTION OF THE DRAWINGS

FIG. 1 illustrates increasing robustness by increasing bit1Luma according to an embodiment of the disclosure.

FIG. 2 illustrates examples of embedding in 8 bit video according to an embodiment of the disclosure.

FIG. 3 illustrates the luma received after video processing using MPEG-H HEVC encoding/deciding according to an embodiment of the disclosure.

FIG. 4 illustrates threshLuma plotted as an overlay for compressed video according to an embodiment of the disclosure.

FIG. 5 illustrates threshLuma calculated with bit0Luma=4 overlaid on a luma signal from a watermark according to an embodiment of the disclosure.

FIG. 6 illustrates threshLuma calculated with bit0Luma=5 overlaid on a luma signal from a watermark according to an embodiment of the disclosure.

FIG. 7 illustrates dynamic parameter tuning using histogram analysis according to an embodiment of the disclosure.

FIG. 8 shows the effect of a broadcast path frame rate up-sampler and resolution converter according to an embodiment of the disclosure.

FIG. 9 illustrates a block diagram of a device that can be used for implementing various disclosed embodiments.

### SUMMARY OF THE INVENTION

This section is intended to provide a summary of certain exemplary embodiments and is not intended to limit the scope of the embodiments that are disclosed in this application.

The disclosed embodiments improve on previous Video Watermarking Systems by using a Gain Adaptation Process to modulate luma values during embedding and using a corresponding and coordinated Gain Adaptation Process to optimize the symbol detection threshold during watermark detection.

The disclosed embodiments relate to a method of psycho-visual-model (PVM) based video watermark gain adaptation. In one embodiment, a method comprises embedding video content with a watermark including watermark symbols, wherein the watermark symbols replace pixels in the video content with pixels in which luma values are modulated such that the luma value for a 0 bit (“Bit0”) renders as black and the luma value for a 1 bit (“Bit1”) renders as a shade of gray. The selection of the luma value for bit 1 takes into account the visual impact of watermark embedding. Also, the method comprises extracting video watermark symbols from embedded content, wherein the extracting includes making a prediction of an expected luma value for bit 1 selected during the embedding in order to calculate the threshold used to discriminate bits 0 and 1.

These and other advantages and features of disclosed embodiments, together with the organization and manner of operation thereof, will become apparent from the following detailed description when taken in conjunction with the accompanying drawings.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present disclosure may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

### Introduction

An example of a video watermarking system which embeds ancillary information into a video signal is found in the ATSC standard A/335, which is incorporated by reference. This system replaces the luma of the top two lines of pixels with a value which is modulated by the ancillary data. Binary data is represented by two different luma values, where the luma value for a ‘0’ bit (“Bit0”) renders as black and the luma for a ‘1’ bit (“Bit1”) renders as a shade of gray. There is often a tradeoff of robustness and visual quality (VQ) when using fixed strength embedding systems: The higher the Bit1 luma value (e.g., 100 for an 8 bit signal), the easier the signal can be to detect, but it is also more visible which can be annoying and distracting to the user.

A/335 describes a system called 1× system where the Bit1 luma value is chosen by the broadcaster to set the desired balance between visibility and robustness and does not describe methods for varying the ‘1’ bit luma value from frame to frame nor within a frame. In A/335, two encoding options are offered, one providing a watermark payload of 30 bytes per video frame (a “1×” version), and the second “2×” version offering double that capacity.

A/335 predicted that visibility would not be a concern: “Visibility of this video watermark is not anticipated to be an issue because ATSC 3.0-aware receivers are expected to be designed with the knowledge that the top two lines of active video may include this watermark, and will thus avoid displaying (by any means desired). The majority of HDTV display systems in use at the time of publication operate by default in an “overscan” mode in which only the central ˜95% of video lines are displayed. Thus, if watermarked video is delivered to a non-ATSC 3.0-aware receiver, the watermark would not normally be seen”. However, many modern TVs will be shipped with default configuration for full frame viewing (a.k.a. “full pixel” mode) and watermark visibility becomes an important quality to minimize.

ATSC standard A/336 (https://muygs2×2vhb2pjk6g160f1s8-wpengine.netdna-ss1.com/wp-content/uploads/2020/06/A336-2019-Content-Recovery-in-Redistribution-Scenarios-with-Amend-1.pdf) describes how signaling information can be carried in the video watermark payload and specifies a type of message called the extended_vp1_message which carries time_offset data that changes every 1/30 seconds. Watermark symbols that change this frequently are subject to distortion introduced during frame rate up-sampling, and during frame prediction for video compression.

An embedder which uses a Psycho-Visual-Model for embedding luma level adaptation is described in U.S. Provisional Patent Application Ser. No. 63/081,917 and in PCT Patent Application No. PCT/US2021/051843 which are incorporated by reference.

This level adaptation process comprises a Psycho-Visual-Model (PVM) to decrease the luma levels in areas of poor visual quality, and a robustness analysis which can increase the luma levels in areas of poor robustness. The level adaptation process is applied in the Embedder to modulate the Bit1 luma value and is used in the Detector to modulate the symbol detection threshold.

The detector can dynamically estimate the PVM parameters that were used in the embedder and can also recognize and correct for some distortions occurring in the transmission channel between the embedder and the detector including luma range limitation and distortions caused by frame interpolation and prediction.

### Improving Signal to Noise by Increasing Bit1Luma

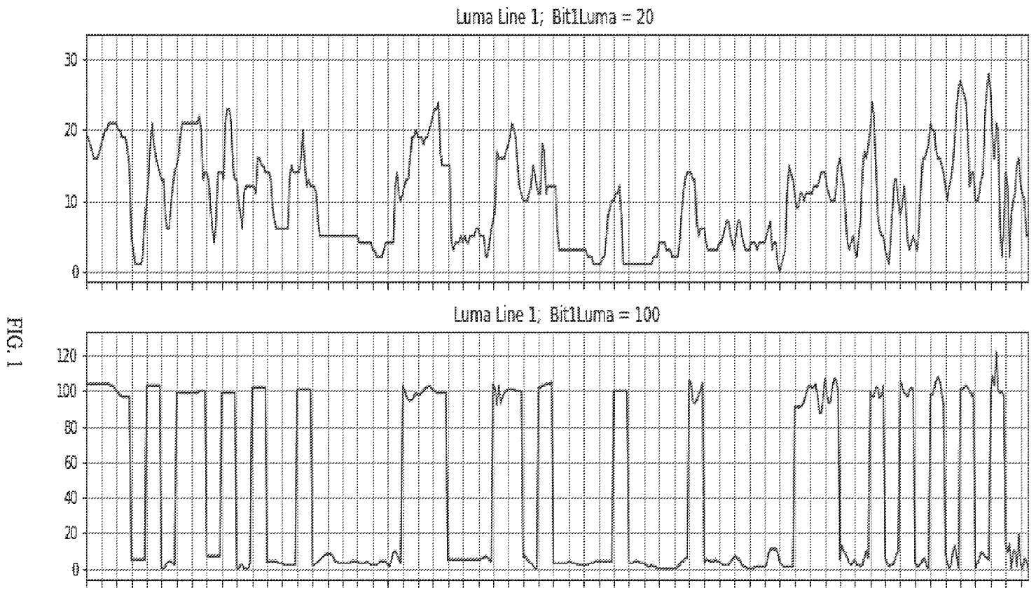

A typical way to increase robustness is to increase the Bit1Luma level. This overcomes noise introduced when the underlying host video is complex with high entropy and motion, by providing a higher signal to noise ratio for the watermark luma signal. This is illustrated in FIG. 1 where complex video is embedded alternately with Bit1Luma=20 and Bit1Lurna=100. The signal with Bit1Luma=100 has much less distortion and is easier to detect than when Bit1Luima=20.

### Psycho-Visual-Model

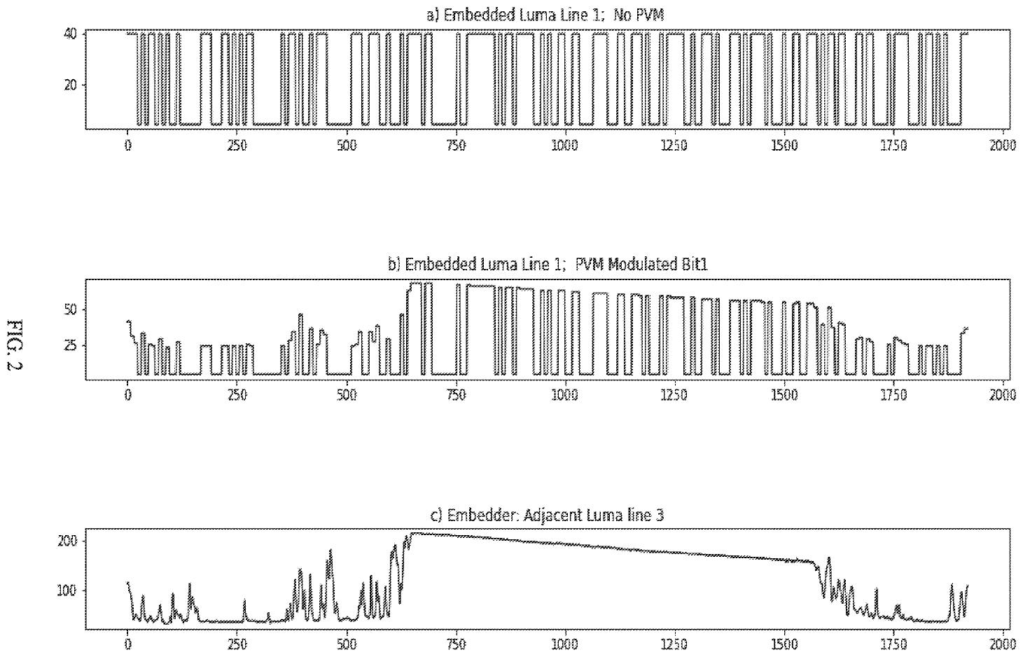

Error! Reference source not found. 2 shows examples of embedding in 8 bit video as described in the previously discussed Serial no. 63/081,917. FIG. 2a shows Bit1 luma=40 for all symbols; FIG. 2b shows Bit1 luma modulated by a PVM function of the adjacent brightness of the third line of video (FIG. 2c).

### Detection of PVM Modulated Luma

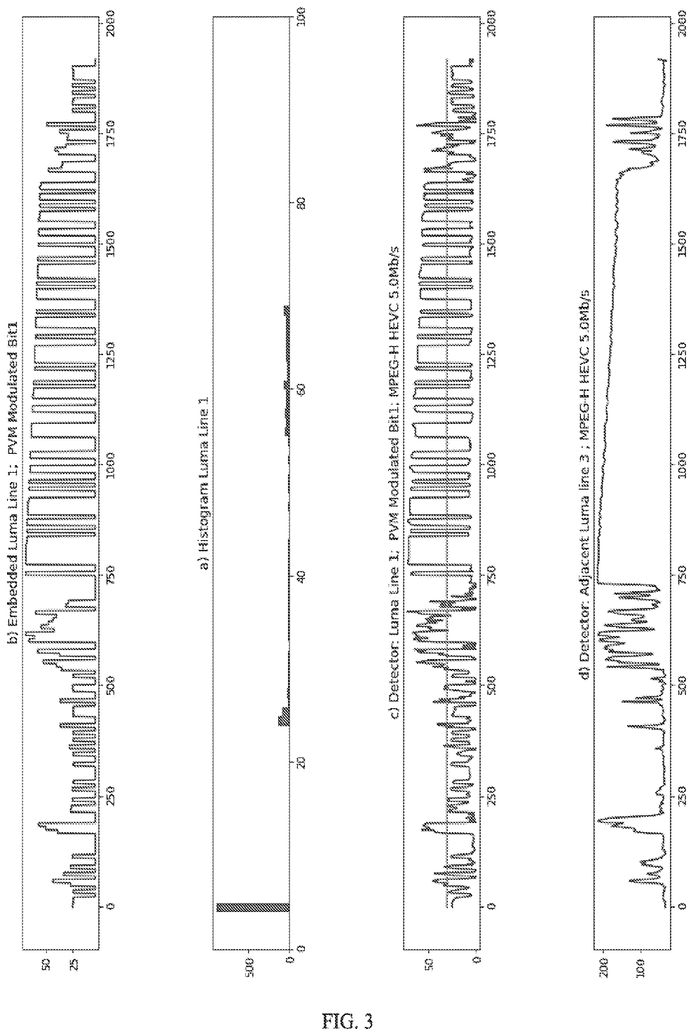

FIG. 3c shows the luma received at a detector after video processing using MPEG-H HEVC encoding/decoding of 16:9 1080p, 30 fps video signal at 5 Mb/s.

A simple detector described in A/335 uses a histogram analysis to determine a symbol detection threshold that is constant across the frame and used for all symbols. Inspection of FIG. 3c shows that a fixed detection threshold (shown as fixed a horizontal line) will fail to correctly detect many symbols.

A solution to this problem involves calculating the detection threshold using the same Level Adaptation Process that is used for setting the bit1Luma level in the Embedder.

An example of a function that calculates a bit1 luma value for an embedded symbol based on adjacent brightness is found in the above-described Serial No. 63/081,917. For each symbol, the average luma value of the adjacent host video is used:

```
func getBit1LumaForSymbol (adjacentBrightness, bit1Min,
bit1Max, percentDimmer) {
  proposedBitLevel = bit1Min +
max( (adjacentBrightness − bit1Min), 0) * percentDimmer
  return min(proposedBitLevel, bit1Max)
}
```

The same function can be used in a detector, along with the luma value the embedder uses for bit0, bit0Luma, to calculate a symbol detection threshold threshLuma, by calculating the midpoint between the embedded bit0 and bit1 values.

bit1ScaledLuma=getBit1LumaForSymbol(adjacentBrightness, bit1Min, bit1Max, percentDimmer)

threshLuma=bit0Luma+bit1ScaledLuma−bit0Luma)/2

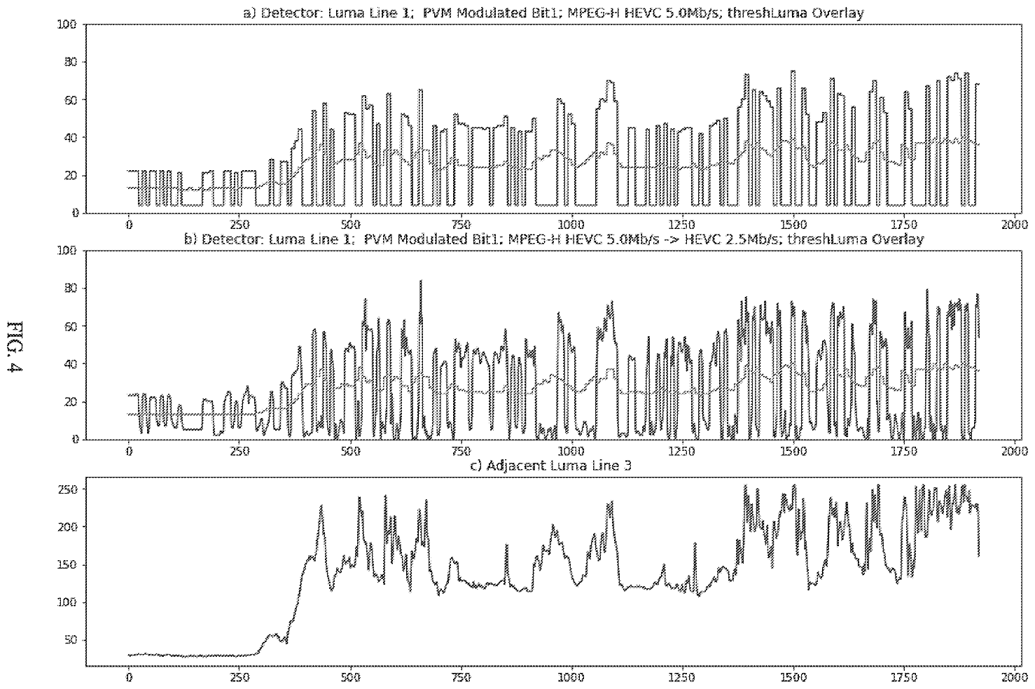

threshLuma is plotted as an overlay in FIG. 4a for a video compressed with MPEG-H HEVC 5.0 Mb/s and in 4b for a video additionally compressed using HEVC 2.5 Mb/s.

### Luma Range Limiting

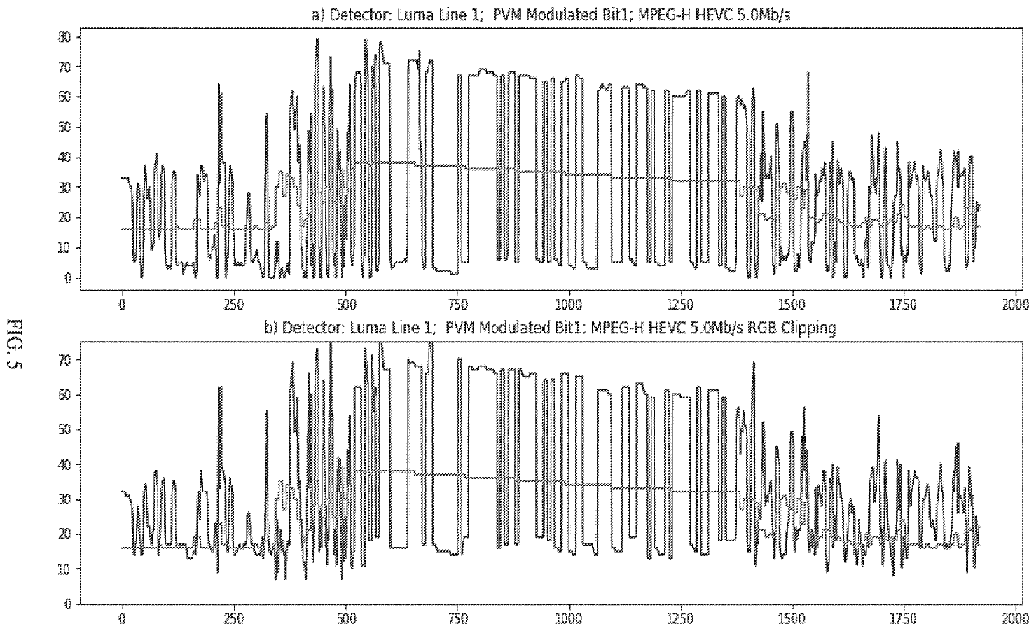

The transmission channel between the Embedder and the Detector can sometimes limit luma signals to a minimum value of 16. For example, conversion from RGB to YCrCb will result in a limited range signal (See https://en.wikipedia.org/wiki/YCbCrp. FIG. 5a shows threshLuma which was calculated with bit0Luma=4 overlaid on a luma signal from a watermark which was embedded with bit0Luma=4 and which is not clipped in the transmission channel. FIG. 5b shows the same threshLuma overlaid on the same embedded signal which was limited in transmission. This illustrates that the detection threshold which is calculated based on the embedded bit0Luma value is no longer the midpoint between the received bit0 and bit1 values and will produce more detection errors.

A solution to this problem is to estimate the bit0Luma value of the received signal in the detector and use that in the threshLuma calculation.

One way to estimate the received bit0Luma value is to use a histogram analysis. The steps to perform this analysis are listed below.
1. Calculate a histogram of the luma signal. As an example for 8 bit luma signals, use a histogram with 256 bins ranging from 0 to 255
2. Set the bit0Luma parameter to the value corresponding to the peak bin for luma values less than 20.

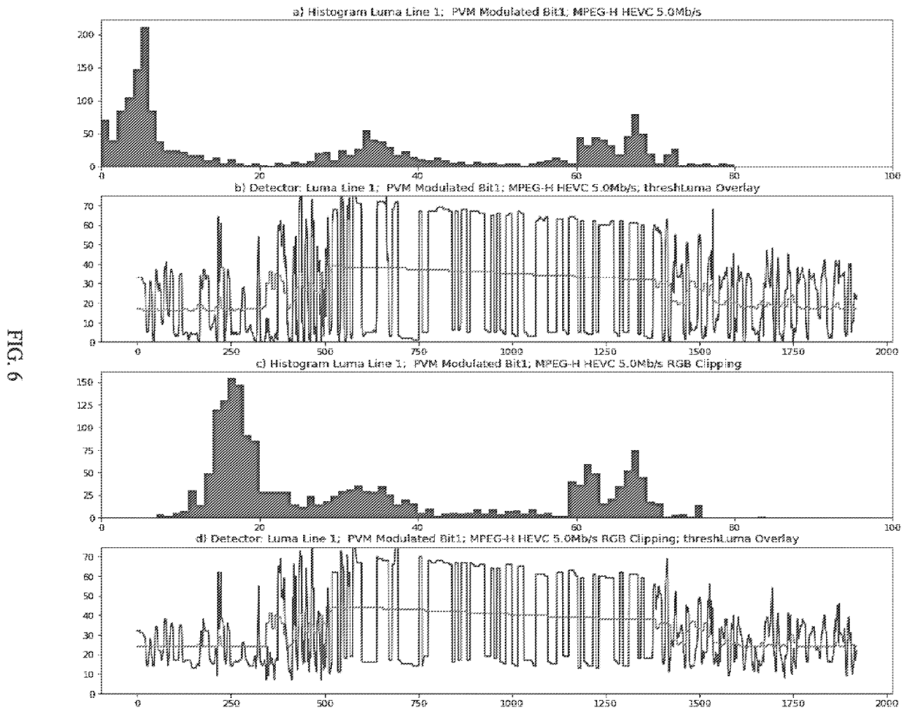

FIG. 6a shows a histogram for an unclipped signal, and the peak bin corresponds to bit0Luma=5. FIG. 6b shows threshLuma calculated with this value overlaid on the luma signal. FIG. 6c shows a histogram for a signal which was clipped in transmission, and the peak bin corresponds to bit0Luma=16. FIG. 6d shows threshLuma calculated with this value overlaid on the clipped luma signal.

An alternative method to estimate bit0Luma is to recognize that luma limiting has been performed prior to reception by detecting one of two conditions: either a) the input is not limited and assume that Bit0=4, or b) the input is limited to 16, consistent with Limited Range YCbCr signal, and assume that Bit0=16. A decision to choose between these two values can be made by comparing the minimum luma value of the watermark to a preselected threshold. As can be seen in FIG. 3b, there is undershoot that can be generated after the luma limiting, and the threshold should be set low enough to account for this. Experimental data has shown that a threshold value of 5 works well for most content. This alternate method can be used when less processing overhead is required. The steps in this alternate method are:
1. Find lumaMin, the minimum luma value of the watermark line of pixels.
2. If lumaMin <5, bit0Luma=4 else bit0Luma=16.

### PVM Model Parameter Estimation in Detector

The parameters for the Level Adaptation Process can be known in advance by both the Embedder and Detector, but sometimes might be dynamically set by the Embedder.

An example of dynamic setting of parameters is to ensure detectability for certain frames which have been identified as important. For example, the starting frame of an ad pod where a replacement ad insertion might occur could be marked as important, and the embedder could tune the parameters for optimal detectability at the expense of visual quality for that frame. Alternatively, when embedder is tasked to embed a message that doesn't include Forward Error Correction (FEC), the embedder may choose to boost robustness, while for frames that carry messages with FEC the embedder may choose to emphasize VQ.

Another example of dynamic setting of parameters uses continuous monitoring to maintain a minimum level of robustness: During embedding, the detectability of the embedded frame can be evaluated in real time by processing the embedded frames using processes similar to those found in the real broadcast path, then running a detector on those processed frames. A detection error metric can then be used to modulate some or all of the parameters to maintain robustness at a desired level.

Another example of dynamic setting of parameters is an embedder that keeps count of the number of undetectable symbols (“devilBitCount”)(e.g., where adjacentBrightness is black) andkeeps minSpreadBit0=0 until devilBitCount exceeds a threshold number of errors that can be corrected by the error detection/correction capability of the system.

In the case of dynamic parameter tuning in the embedder, the Detector can try to estimate the parameter values. Bit0Luma can be estimated as described above. Other embedding parameters such as percentDimmer, bit1Min, and bit1Nominal can be estimated using the techniques below.

First, bit1Nominal luma value will only be embedded if it is less than the proposedBitLevel, or if fixed strength embedding was done where bit 1Min=bit1Nominal. This can be determined by a histogram analysis:
1. Calculate a histogram of the watermark luma signal. As an example, for 8 bit luma signals, use a histogram with 256 bins ranging from 0 to 255
2. Find the peak bin for watermark luma values greater than 20.
3. Calculate the ratio of the histogram count for the peak bin to the count of all bins for luma greater than 20. This will be very close to 1.0 when PVM was not used and less than 0.5 when PVM was used during embedding. Note that this ratio might also be close to 1.0 when PVM is used but the adjacent luma has no variance, but the threshLuma calculations will be the same for both cases. If PVM was not used (or if adjacent luma has no variance) set the estimates for bit1Min and bit1Nominal to the peak bin index. If PVM was used (and adjacent luma varies) set only bit1Nominal to the peak bin index and estimate the other parameters as described below. Note that the embedding bit1Nominal could have been higher than this estimate, but since clipping doesn't occur in this frame this lower estimate will yield the same threshLuma results.

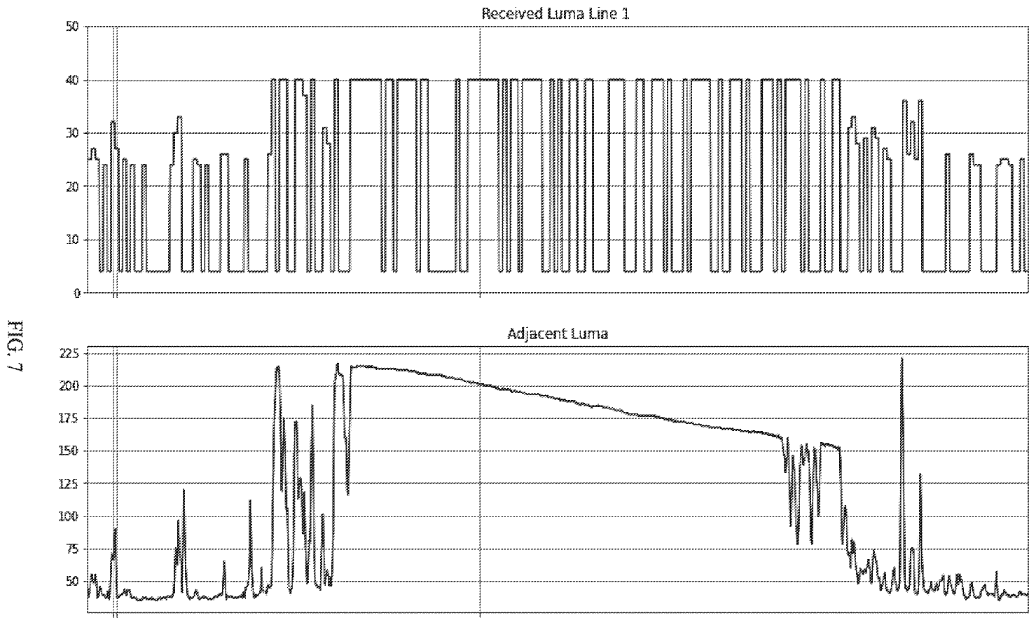

This is illustrated in FIG. 7 which shows the received watermark luma signal and the luma of the adjacent host content. This watermark was embedded with percentDimmer=0.25, bit1Nominal=40, and bit1Min=20. The received symbols in middle of the payload have bit1Luma values ˜40 while the adjacentBrightness luma is steadily decreasing which indicates clipping to bit1Nominal has occurred. To estimate bit1Nominal, the 100^{th} symbol is used and is marked with a vertical grid line. The average value of the luma across the pixels in the symbol is equal to 40, which is the same as embedded value.

bit1Min might also be exposed if adjacentBrightness is less than bit 1Min, and this can be detected in a similar way by observing different values for the received bit1Luma for symbols which are adjacent to different adjacentBrightness values. If this clipping is detected, the received bit1Luma can be used as the estimate for bit 1Min. In the example of FIG. 7, there is no apparent clipping to bit1Min, so it must be calculated as described below.

If Bit1Min is not exposed through the above procedure, it can be estimated along with percentDimmer by choosing two received symbols that are below the estimated bit1Nominal level and using any well-known technique for solving a system of two variables using two equations. Two points are chosen and the adjacent brightness for each is measured as sym1Adj and sym2Adj, and the received average luma of the watermark is calculated as sym1Luma and sym2Luma. The two equations can be solved:

$$sym 1 Luma = bit 1 Min + ( sym 1 Adj - bit 1 Min ) * percentDimmer$$

$$sym 2 Luma = bit 1 Min + ( sym 2 Adj - bit 1 Min ) * percentDimmer$$

Subtracting the two equations to solve for percentDimmer:

$$percentDimmer = ( sym 1 Luma - sym 2 Luma ) / ( sym 1 Adj - sym 2 Adj )$$

Then solving for bit1Min:

$$bit 1 Min - ( sym 1 Luma - sym 1 Adj * percentDimmer ) / ( 1 - percentDimmer )$$

For FIG. 7, the 6^{th} and 7^{th} symbols were chosen and are indicated by two vertical grid lines. The values measured were:
sym1Luma=32
sym2Luma=27
sym1Adj=71.12
sym2Adj=50.75

The calculated values are:
percentDimmer=0.245=>−1.8% error bit1Min=19.28=>−3.6% error

### Segmented Embedding and Detecting

The dynamic parameter tuning described above can be done for all symbols in a payload but can also be done selectively for one or more subsets of the symbols in a payload. This can be done to improve the robustness of those symbols without negatively impacting picture quality in the rest of the frame. An example is the time_offset data described in A/336. When embedding, Bit1Luma can be increased for the symbols containing the time_offset data. When detecting, the time_offset symbols can be analyzed separately and the embedding parameters and the bit0Luma value can be estimated just for those symbols using the techniques described above.

### Channel Envelope Distortion

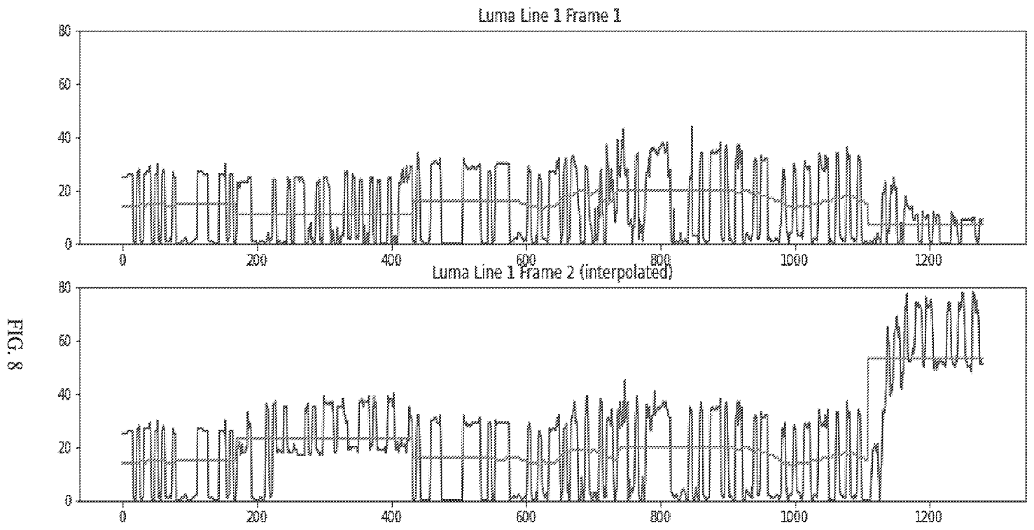

Intermediate processing between the embedder and detector can sometimes change the amplitude envelope of the watermark luma signal. For example, FIG. 8 shows the effect of a broadcast path frame rate up-sampler and resolution converter. Frame 1 contains a watermark payload that was embedded, and Frame 2 is an interpolated frame. The fast-changing symbols in the pixel ranges 170 to 426 and 1109 to 1280 exhibit these envelope distortions. A detector was constructed using the techniques described above to separately estimate the PVM parameters for these two areas and was able to correct for the envelope distortion by basing bit1Min and bit1Nominal estimates on the received signal.

### Timeline Data

### Background

A/336 specifies two messages that are used to convey timeline information, and which have values that can change every frame. The extended_vp1_message( ) uses 8 symbols to convey a time_offset counter which has a resolution of 1/30 sec, and the presentation_time_message( ) uses 42 symbols to convey International Atomic Time (TAI).

An important use case for timeline information is trick play tracking, where the watermarked content is stored on a digital video recorder and the user can control the timeline of playback with commands such as pause, skip forward, skip backward, and reverse and forward play at various speeds. When supplementary content is synchronized to the watermark content, it is desirable to recover the timeline information for every frame to maintain tight synchronization during trick play. When timeline information can't be recovered during synchronized playback, the last valid timing information can be used but this simulates a paused state which can be confusing for the viewer. One way to overcome this is to avoid pausing the synchronized content until new valid timeline information is detected, but this too can be confusing if the viewer happened to pause the watermarked content on the undetectable frame. A further remedy of this situation is to use advanced analysis to determine if the repeated frame being processed by the watermark detector is a paused frame or if it is a sequence of unique frames which happen to have distorted and unrecoverable watermarks. One way to do this advanced processing is to compare the CRC bits of the unrecoverable payload. For a paused frame they will be nearly identical and provide an actionable signal to indicate a paused state.

Watermark symbols that do not change from frame to frame tend to be more robust to errors introduced during frame rate conversion and codec frame prediction than watermark symbols which change from frame-to-frame.

New frames based on embedded frames will sometimes be synthesized in the channel between the Embedder and the Detector. For example, a frame rate conversion will sometimes interpolate new frames (See https://en.wikipedia.org/wiki/Frame_rate) between two successive embedded frames. These interpolated frames add no new information to the watermark payload and can introduce errors when the watermark symbols change between frames.

Another example is when video codecs use predicted inter frames such as P-frames and B-frames as part of the compression algorithm (See https://en.wikipedia.org/wiki/Inter_frame). Symbols that don't change from frame to frame are easier to predict.

Several techniques are described below to improve robustness for waternark symbols which change from frame-to-frame.

### Increase Codec Bitrate

For a given codec, the fidelity of the predicted frame depends primarily on the amount of compression applied to the video. Codec prediction errors can be mitigated by increasing the bit rate of the codec.

### Repeat Frames

Errors can be reduced by repeating watermark payloads. For the case of the extended_vp1_message( ) in A/336, the tradeoff is decreasing the resolution of the time_offset counter. For example, if a new time_offset is chosen every other frame at 30 fps, the resolution of the timing information decreases from 1/30 second to 1/15 second, but the probability of detection increases because of the repeated frame. Repeating frames is the only technique effective for frame rate conversion interpolation errors: It will not make the interpolated frames easier to detect but will reduce the probability of landing on one during trick-play.

### Increase Bit1Luma

Increasing Bit1Luma during embedding can help overcome prediction errors but has little effect on up-sampling interpolation errors. One way to increase Bit1Luma for just the time_offset symbols without increasing it for the rest of the payload is described above in Segmented Embedding and Detecting.

### Add Error Correction

Neither time_offset nor presentation_time_message( ) in A/336 utilize error correction to improve robustness.

A new payload which carries the time_offset and error correction parity bits can be used to improve robustness. For example, a BCH (127, 50, 13) Bose-Chaudhuri-Hocquenghem Error Correction Code having a 127-bit codeword with 50 information bits could correct up to 13 bit-errors. 8 bits could be used for the time_offset, and the remaining bits could be used to uniquely identify the content so that channel changes could be quickly detected. Such a payload could be transmitted interleaved with the extended_vp1_message( ) to improve robustness of timeline recovery.

Also, the existing extended_vp1_message( ) could be modified to use the 32 header bits to carry error correction parity bits and still be compatible with existing detectors which are not required to properly detect the VP1 header in order to decode the VP1 payload.

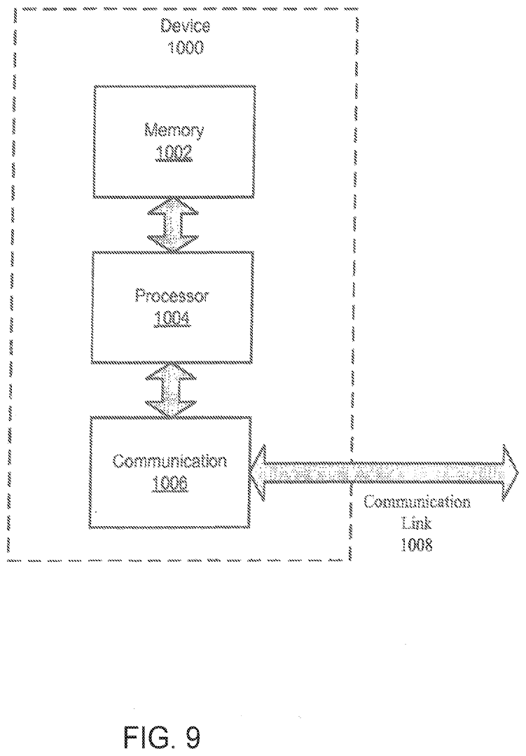

It is understood that the various embodiments of the present disclosure may be implemented individually, or collectively, in devices comprised of various hardware and/or software modules and components. These devices, for example, may comprise a processor, a memory unit, an interface that are communicatively connected to each other, and may range from desktop and/or laptop computers, to consumer electronic devices such as media players, mobile devices and the like. For example, FIG. 9 illustrates a block diagram of a device 1000 within which the various disclosed embodiments may be implemented. The device 1000 comprises at least one processor 1002 and/or controller, at least one memory 1004 unit that is in communication with the processor 1002, and at least one communication unit 1006 that enables the exchange of data and information, directly or indirectly, through the communication link 1008 with other entities, devices and networks. The communication unit 1006 may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information.

Referring back to FIG. 9 the device 1000 and the like may be implemented in software, hardware, firmware, or combinations thereof. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present disclosure to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present disclosure in various embodiments and with various modifications as are suited to the particular use contemplated. The features of the embodiments described herein may be combined in all possible combinations of methods, apparatus, modules, systems, and computer program products.

What is claimed is:

1. A method comprising:
a. embedding video content with a watermark including watermark symbols, wherein the watermark symbols replace pixels in the video content with pixels in which luma values are modulated such that the luma value for a 0 bit (“Bit0”) renders as black and the luma value for a 1 bit (“Bit1”) renders as a shade of gray, and wherein the selection of the luma value for bit 1 takes into account the visual impact of watermark embedding; and
b. extracting video watermark symbols from embedded content, wherein the extracting includes making a prediction of an expected luma value for bit 1 selected during the embedding in order to calculate the threshold used to discriminate bits 0 and 1.

2. The method of claim 1 wherein the embedding further comprises making the selection of the luma value for bit 1 for each symbol independent of other symbols.

3. The method of claim 1 wherein the embedding further comprises making the selection of the luma value for bit 1 for a group of symbols simultaneously.

4. The method of claim 1 wherein the extracting further comprises making the prediction of the selected luma value for bit 1 for each symbol independently.

5. The method of claim 1 wherein the extracting further comprises making the prediction of the selected luma value for bit 1 for a group of symbols simultaneously.

6. The method of claim 1 wherein the extracting further comprises attempting to predict the selected luma value for bit 1 based on a known embedder design.

7. The method of claim 1 wherein the extracting further comprises attempting to predict the selected luma value for bit 1 without considering the embedder design.

8. The method of claim 1 wherein the extracting further comprises analyzing the watermark luma values to determine if the embedding used the same luma value for bit 1 in an entire frame. (=fixed strength embedding)

9. The method of claim 1 wherein the embedded content is transmitted through a transmission channel, and the extracting further comprises analyzing the watermark luma values to determine if the transmission channel includes luma range limiting or other envelope distortion, and wherein the extracting uses the determination regarding the transmission channel to calculate a threshold that is used to discriminate bits 0 and 1.

10. The method of claim 1 wherein the embedding further comprises selectively increasing the luma value for bit 1 watermark symbols that change frame to frame, whereby robustness is improved.

11. The method of claim 1 wherein the embedding further comprises selectively increasing the luma value for bit 1 time_offset watermark symbols, whereby robustness is improved.

12. A method comprising:
a. embedding video content with a watermark including watermark symbols, wherein the watermark symbols replace pixels in the video content with pixels in which luma values are modulated such that the luma value for a 0 bit (“Bit0”) renders as black and the luma value for a 1 bit (“Bit1”) renders as a shade of gray, and wherein the embedding uses forward error correction to include extra symbols containing redundant data for watermark symbols that change frame to frame, whereby robustness is improved; and
b. extracting video watermark symbols from embedded content, wherein the extracting includes detecting and correcting data errors using extra forward error correcting symbols included by the embedding.
